(19) United States
(12) Patent Application Publication
(10) Pub. No.: US 2026/0082163 A1
(43) Pub. Date: Mar. 19, 2026

(54) MIXED-DELAY SIGNAL PROCESSING FOR HEARING DEVICES

(71) Applicant: The Board of Trustees of the University of Illinois, Urbana, IL (US)

(72) Inventor: Ryan M. Corey, Chicago, IL (US)

(21) Appl. No.: 19/329,685

(22) Filed: Sep. 16, 2025

Related U.S. Application Data
(60) Provisional application No. 63/695,286, filed on Sep. 16, 2024.

(51) Int. Cl. H04R 25/00; H04R 1/10

(52) U.S. Cl. CPC H04R 25/507; H04R 1/1083; H04R 2225/43; H04R 2460/01

(57) ABSTRACT

Various examples are provided related to mixed-delay signal processing. In one example, a communication device includes at least one microphone positioned to capture sound signals from a surrounding environment; and processing circuitry operatively connected to the microphone(s), where the processing circuitry can generate audio signals from the sound signals captured by the microphone(s) and process the audio signals through dual algorithmic processing. In another example, a method includes separating audio signals corresponding to sound signals associated with a main source of sound and audio signals corresponding to sound signals associated with a secondary source of sound; processing the audio signals corresponding to the main source sound signals at a first low latency or delay and the secondary source sound signals at a second latency or delay higher than the first low latency or delay; and combining the processed audio signals for output to an output transducer.

### CROSS REFERENCE TO RELATED APPLICATIONS

This application claims priority to, and the benefit of, U.S. provisional application entitled “Mixed-Delay Signal Processing for Hearing Devices” having Ser. No. 63/695,286, filed Sep. 16, 2024, which is hereby incorporated by reference in its entirety.

### STATEMENT REGARDING FEDERALLY SPONSORED RESEARCH OR DEVELOPMENT

This invention was made with government support under Grant No. 1919257 awarded by the National Science Foundation. The government has certain rights in the invention.

### BACKGROUND

Hearing aids are critical devices designed to assist individuals with hearing loss by amplifying external sounds, improving speech intelligibility, and enhancing overall auditory perception. Historically, analog hearing aids dominated the market, offering near-instantaneous sound amplification with delays typically less than 1 millisecond. While these devices provided essential sound amplification, they lacked advanced features such as dynamic noise reduction, feedback management, speech enhancement, and wireless connectivity. These advanced features, made possibly by digital hearing aids, generally require greater processing delay, which can be disturbing to users. Delay is a key limiting factor on the performance of hearing aid signal processing.

### SUMMARY

Aspects of the present disclosure are related to mixed-delay signal processing. In view of the disadvantages inherent in known types of optimization for hearing aids present in the prior art, the present disclosure provides dual algorithmic optimization wherein a device can simultaneously process two or more sources of sound at different latencies. As used herein, processing latency or delay are used interchangeably. The source of sound can be a single source or can be a combination of sources such as in the case of background noise. For example, a user's own voice is a single source of sound, just as an external talker is a single source. Alternatively, noise from a HVAC system is usually emitted from multiple vents and thus, while from a single source, is distributed from different locations. Similarly, a group of people talking together can be considered a source of sound. An individual's brain naturally makes these determinations.

The present disclosure presents examples of devices, systems, and methods, which will be described subsequently in greater detail, that can process two or more sources of sound at varying latency or delay based on a hierarchical ranking of the source. This can benefit hearing aid wearers by providing more comfort from own voice annoyance (OVA) while simultaneously providing clear external sound not from the user.

To attain this, a hearing/listening device can comprise one or more microphones to capture an audio signal that is then processed by processing circuitry including, e.g., a digital signal processing (DSP) unit, central processing unit (CPU), application-specific integrated circuit (ASIC), or other appropriate general-purpose processor or application-specific circuit. The processing circuitry (e.g., DSP unit) splits the audio signal by understanding the main source of sound, and assigning it to a low latency algorithmic path, and determining external or secondary, tertiary, or higher sound source rankings, where they are processed at a higher latency or delay. In a separate embodiment, the higher ranked audio signals can each be assigned to a separate algorithmic path, each with a different latency. In both embodiments specified herein, the DSP unit also outputs processed output audio signals to an output transducer (e.g., receiver) for user hearing.

The foregoing has thus outlined, rather broadly, features of the present disclosure in order that the present contribution may be better appreciated. There are additional features of present disclosure that will be described hereinafter and that will form the subject matter of the claims appended hereto.

In this respect, before explaining aspects of the present disclosure in detail, it is understood that the aspects of present disclosure are not limited in its application to the details of construction and to the arrangements of the components set forth in the following description or illustrated in the following drawings.

The aspects of present disclosure are capable of other embodiments and of being practiced and carried out in various ways. Also, it is to be understood that the phraseology and terminology employed herein are for the purpose of the description and should not be regarded as limiting.

In one aspect, among others, a communication device comprises at least one microphone positioned to capture sound signals from a surrounding environment; and processing circuitry operatively connected to the at least one microphone, where the processing circuitry is configured to generate audio signals from the sound signals captured by the at least one microphone and process the audio signals through dual algorithmic processing, whereby: audio signals corresponding to a main source of sound are processed with a first low latency or delay to generate processed audio signals; audio signals corresponding to a secondary source of sound are processed with a second latency or delay to generate processed audio signals, the second latency or delay higher than the first low latency or delay; and the processed audio signals are output to an output transducer for user hearing. In one or more aspects, the communication device can be a hearing device (e.g., hearing aids or augmented-reality headsets). The main source of sound can be a user's own speech or an external talker's speech.

In various aspects, the processing circuitry can comprise a digital signal processor (DSP) unit that separates the audio signals from the main source of sound and audio signals from the secondary source of sound. The at least one microphone can comprise one or more local microphone. The processing circuitry can comprise a fixed beamformer configured to receive sound signals from the at least one microphone and provide the audio signals from the main source of sound for processing with the first low latency or delay. The processing circuitry can comprise a blocking matrix configured to receive the sound signals from the at least one microphone and provide the audio signals from the secondary source of sound for processing with the second higher latency or delay. The DSP unit can comprise an adaptive cancellation filter configured to receive the audio signals corresponding to the secondary source of sound from the blocking matrix and provide a filtered output for cancellation of the audio signals from the main source of sound from the fixed beamformer. The audio signals corresponding to a tertiary source of sound can be processed with a third latency or delay to generate processed audio signals, the third latency or delay higher than the first low latency or delay and different than the second latency or delay. The communication device can be wearable by a user. The communication device can be paired with a second communication device, the paired communication devices jointly processing the audio signals captured by the at least one microphone.

In another aspect, a communication system comprises at least one microphone positioned to capture sound signals from a surrounding environment; and processing circuitry wirelessly connected to the at least one microphone, where the processing circuitry is configured to receive audio signals generated from the sound signals by the at least one microphone and process the audio signals through dual algorithmic processing, whereby: audio signals corresponding to a main source of sound are processed with a first low latency or delay to generate processed audio signals; audio signals corresponding to a secondary source of sound are processed with a second latency or delay to generate processed audio signals, the second latency or delay higher than the first low latency or delay; and the processed audio signals are output to an output transducer for user hearing. A communication device wearable by a user can comprise the processing circuitry and the at least one microphone can comprise at least one remotely located microphone. The processing circuitry can comprise a digital signal processor (DSP) unit that separates the audio signals from the main source of sound and audio signals from the secondary source of sound.

In another aspect, a method for mixed-delay signal processing comprises generating audio signals from sound signals received by one or more microphone; separating audio signals corresponding to sound signals associated with a main source of sound from the generated audio signals; separating audio signals corresponding to sound signals associated with a secondary source of sound from the generated audio signals; processing the audio signals corresponding to sound signals associated with the main source of sound at a first low latency or delay to generate first processed audio signals; processing the audio signals corresponding to sound signals associated with the secondary source of sound at a second latency or delay to generate second processed audio signals, the second latency or delay higher than the first low latency or delay; and combining the first and second processed audio signals for output to an output transducer. In one or more aspects, the audio signals corresponding to sound signals associated with the main source of sound can be separated using a fixed beamformer or using a neural network. The audio signals corresponding to sound signals associated with the secondary source of sound can be separated using a blocking matrix. The main source of sound can be a user's own speech and the secondary source can be an external talker's speech. In various aspects, the method can further comprise separating audio signals corresponding to sound signals associated with a tertiary source of sound from the generated audio signals; processing the audio signals corresponding to sound signals associated with the tertiary source of sound at a third latency or delay to generate third processed audio signals, the third latency or delay higher than the first low latency or delay and different than the second latency or delay; and combining the third processed audio signals with the first and second processed audio signals for output to the output transducer. The tertiary source can be based upon distance, direction, or both from the one or more microphone.

In another aspect, a communication device comprises processing circuitry (e.g., a DSP unit) that separates audio signals associated with a main source of sound and secondary source of sound using a beamforming technique. In another embodiment, these beamforming techniques comprise a fixed beamformer, and/or a blocking matrix, and/or an adaptive cancellation filter. A processor for processing the sound, and/or an operably linked A/neural network or comparable system can optimize processing of the audio signals. In another aspect, the communication device can comprise a DSP unit or other processing circuitry that can separate audio signals associated with the main source of sound and the secondary source of sound using AI. In another aspect, the communication device can contain the DSP unit that separates the audio signals associated with the main source of sound and the secondary source of sound by using neural networks.

In another aspect, the communication device can contain processing circuitry (e.g., a DSP unit) that separates audio signals of the main source of sound and the secondary source of sound by placing a microphone on or near the main sound source, and a second microphone on or near the secondary sound source; or the placement of a microphone array comprising more than one microphone. Placement of microphones can also be selected to address the cancellation of secondary or tertiary sound sources such as fixed machinery or background noises. By placing microphones adjacent to a known sound source, it can assist in separation of the signal during processing. In another aspect, the forgoing DSP unit embodiments can be combined in any combination to separate sound sources. In an additional aspect, the communication device can be worn by a user. Further in another aspect, the wearable embodiment can include any combination of the DSP units, ASIC, or other processing circuitry within.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1A illustrates an example of mixed-delay signal processing for hearing devices, in accordance with various embodiments of the present disclosure.

FIG. 1B graphically illustrates an example of local and remote devices capturing audio signals from user's own speech and external sounds, in accordance with various embodiments of the present disclosure.

FIG. 2 illustrates an example of the dual low and high latency processing pathways for own speech and external sound, in accordance with various embodiments of the present disclosure.

FIG. 3 graphically illustrates an example of separation between amplified own speech/external sound and residual external sound/own speech for the dual low and high latency processing pathways, in accordance with various embodiments of the present disclosure.

FIG. 4 illustrates an example of own speech separation performance as a function of estimation delay (α_{own}) with stationary subjects, in accordance with various embodiments of the present disclosure.

FIG. 5 illustrates an example of own speech separation performance as a function of estimation delay (α_{own}) with subjects moving in place, in accordance with various embodiments of the present disclosure.

FIG. 6 illustrates an example of user's own speech and external talker's speech in low delay and high delay outputs with all participants sitting still, in accordance with various embodiments of the present disclosure.

### DETAILED DESCRIPTION

Disclosed herein are various examples related to mixed-delay signal processing. Reference will now be made in detail to the description of the embodiments as illustrated in the drawings, wherein like reference numbers indicate like parts throughout the several views.

The advent of digital signal processing (DSP) in hearing aids has led to transformative improvements in sound quality, enabling sophisticated features such as adaptive noise reduction, directional microphone systems, and feedback cancellation. These advancements allow hearing aid users to experience clearer sound, particularly in complex auditory environments such as crowded or noisy areas. However, the complexity of DSP requires time to process the incoming sound signals, introducing processing delays typically between 2 and 10 milliseconds. More powerful processing can add several tens of milliseconds in processing delay.

One of the key challenges introduced by DSP-based delays is the perceptual interaction between the delayed, processed sound and the direct, unamplified sound that reaches the ear naturally. This interaction can lead to comb-filtering effects, which distort the sound by introducing spectral peaks and dips, resulting in unnatural tonal colorations that negatively impact sound quality. The problem is particularly pronounced when users hear their own voice through the hearing aid, as the direct bone-conducted sound and the delayed, air-conducted sound interact at the eardrum. Delays as short as 3 milliseconds can be perceptible for normal-hearing individuals, and delays between 5 to 10 milliseconds are often experienced as annoying or disruptive, leading to a phenomenon known as own-voice annoyance (OVA).

OVA has emerged as a significant barrier to the adoption and consistent use of hearing aids, as users may find their own voice unnatural or uncomfortable, particularly during activities such as speaking in conversations or on the phone. This discomfort can lead to reduced device usage or the rejection of hearing aids altogether, even when they are programmed with clinically appropriate gain settings.

Moreover, the need to minimize processing delay has become a critical design constraint for hearing aid manufacturers. Delays are typically kept below 10 milliseconds, a threshold generally accepted by the industry as the upper limit for user comfort. However, this constraint limits the development of advanced algorithms, such as acoustic feedback suppression, improved noise cancellation, and speech enhancement technologies, which could further improve the hearing experience, especially in challenging auditory environments. Advanced processing techniques, such as beamforming and machine learning-based noise reduction, often require longer delays operating optimally but cannot be fully implemented without negatively impacting user perception.

Another challenge faced by modern hearing aid designs is the integration of wireless technologies. Wireless streaming from external devices, such as smartphones, televisions, or remote microphones, is increasingly common, offering users a seamless connection to digital media. However, wireless systems introduce additional transmission delays, typically in the range of 10 to 50 milliseconds, due to signal encoding, transmission, and decoding processes. For external sounds, such delays may be tolerable and less noticeable. However, for own-voice sounds, such delays can lead to significant echo effects, which are disturbing and can reduce the perceived quality of the hearing aid.

Recent studies have shown that users with severe hearing loss may tolerate longer delays, especially with closed-fit or occluding devices, as the natural sound reaching the eardrum is attenuated, reducing the comb-filtering effect. However, individuals with mild to moderate hearing loss are more sensitive to these delays, as the balance between the direct and processed sound is more pronounced.

Furthermore, while the current industry standard aims to keep processing delays below 10 milliseconds, research has shown that users are more sensitive to delays in their own speech than external sounds. This has led to proposals for hearing aids to adopt separate signal processing pathways for own speech and external sounds. By allowing greater delay for external sounds, manufacturers could implement more advanced processing algorithms that improve speech intelligibility in noisy environments without sacrificing user comfort for their own voice. Novel mixed-delay algorithms could also apply different delay constraints for different types of external sound, such as speech and music, or for nearby and more distant sounds.

In light of these challenges, there is a growing need for innovative solutions that can manage the trade-offs between low latency processing, advanced signal processing capabilities, and wireless integration. Addressing these issues could significantly improve user satisfaction, increase hearing aid adoption rates, and allow for the development of more sophisticated features that provide a better auditory experience for individuals with hearing loss.

In hearing devices, an important design consideration is the user's perception of their own speech. It has been suggested that own-speech annoyance could be a barrier to hearing aid adoption and tolerance of clinically appropriate gain levels. Additionally, stricter delay requirements exist for own-speech processing compared to external sounds, making the own-speech pathway a limiting factor in signal processing architectures. Normal-hearing listeners can notice own-speech delays as short as 3 ms and are disturbed by delays of 5-10 ms. On the other hand, listeners with more severe hearing loss can tolerate longer delays, up to 30 ms, especially with closed-fitting (occluding) devices. Recent studies found that users, regardless of hearing loss, are less disturbed by delays in external sounds than by delays in their own voice, particularly when the processed sound is significantly louder than the direct acoustic path.

Given these stricter constraints on own-speech processing, building separate signal processing pathways for the user's own speech and external sounds could be beneficial. While clinical evidence for the advantages of such an approach is limited, one industry-led study reported that listeners preferred a feature that applied softer gain to their own voices. Nevertheless, there would be clear engineering benefits to relaxing processing delay constraints for external sounds. Significant research has already focused on developing low latency algorithms for hearing devices. By removing the requirement of few-millisecond delays for conventional hearing aids, external sound processing pathways could use longer group delays, process data in larger blocks, and even incorporate data from high latency wireless systems.

This disclosure explores own-speech separation based on spatial processing, which can achieve lower delays compared to single-channel separation methods. In causal microphone-array beamforming, the delay-performance curve is heavily influenced by the geometry of the array and the source. Large, distributed arrays with microphones placed close to sound sources can predict sound at the ears before it arrives, achieving a negative effective delay. For instance, many commercial hearing aids can be paired with remote microphone accessories that transmit low-noise, low-reverberation sound directly to the listener's ears. Remote microphones have been shown to dramatically improve speech intelligibility in noisy environments.

With wired or analog wireless microphones, transmission delay is negligible, allowing the remote signal to be aligned with the signal at the ears, thus providing a seamless listening experience. However, digital wireless systems often experience transmission delays in the tens of milliseconds, which can create a disturbing own-speech echo. While such a delay is intolerable for the user's own speech, it may be less noticeable when the delayed sound originates from a distant talker. Therefore, own-speech and external-sound processing branches can operate at different points along the delay-performance curve.

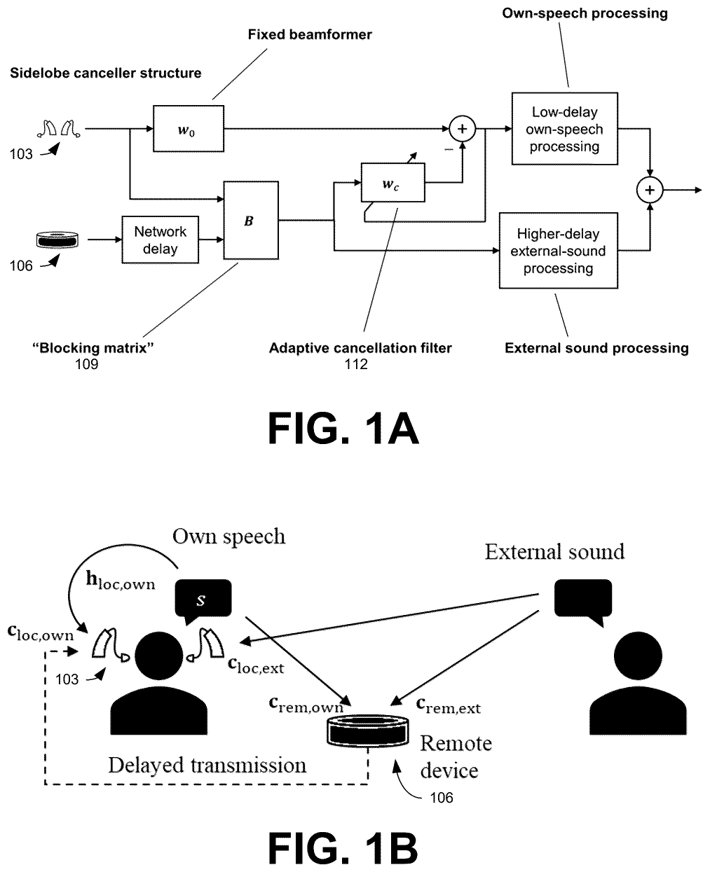

FIG. 1A illustrates an example of a mixed-delay system 100. The proposed mixed-delay beamforming system 100 uses a combination of local microphones 103, which provide instantaneous signals, and remote microphones 106, which experience some delay. This configuration separates the user's own speech, adhering to strict delay constraints, while allowing the processing of external sounds with relatively longer delays. For example, the low latency or delay can be about 3 millisecond or less, about 2.5 ms or less, about 2 ms or less, or about 1.5 ms or less and high latency or delay can be about 5 ms or more, about 6 ms or more, about 7, ms or more, about 8 ms or more, about 9 ms or more, about 10 ms or more, about 12 ms or more, about 14 ms or more, about 16 ms or more, or higher delays. A sidelobe-canceller-like structure employs a causal blocking filter 109 to remove the user's speech from both local and/or remote microphones 103/106, producing external-sound reference signals for an adaptive cancellation filter 112. This system can be viewed as a causal version of the generalized sidelobe canceller with external microphones. In a typical use case, the greater performance burden falls on the higher-delay processing branch.

### Own-Speech Separation System

Signal Model. In one example, a communication device optimized for dual low-delay and high-delay processing can be configured as illustrated in the example of FIG. 1B. In this example, a user wears a listening device with M_{loc} microphones 103, at least one of which is placed in or near each ear to act as a reference microphone to preserve spatial cues. The sampled signal recorded at the ears is x_{loc}[n]∈ [symbol] ^{M}^{_{loc}} for discrete-time indices n. It is given by:

$$\begin{matrix}{x}_{loc} [ n ] & = & {c}_{loc , own} [ n ] + {c}_{loc , ext} [ n ] , & ( 1 ) \\ & = & ( {h}_{loc , own} * s ) [ n ] + {c}_{loc , ext} [ n ] & ( 2 )\end{matrix}$$

where * denotes linear discrete-time convolution, c_{loc,own}[n] and c_{loc,ext}[n] are the own-speech and external sound signals, respectively, at the local microphones, s[n] is the speech of the user, and h_{loc,own}[n]∈ [symbol] ^{M}^{_{loc}} is the sampled impulse response of the own-speech acoustic pathway. Because the local microphones are physically attached to the source of the sound, it is assumed that h_{loc,own}[n] is causal, short, fixed, and known.

One or more remote microphone devices 106 with a total of Mᵣₑₘ microphones also capture nearby sound. The audio signal recorded at the remote device(s) is xᵣₑₘ[n]∈ [symbol] ^{M}^{ᵣₑₘ} and is given by:

$${x}_{rem} [ n ] = {c}_{rem , own} [ n ] + {c}_{rem , ext} [ n ] , \qquad ( 3 )$$

where c_{rem,own}[n] and c_{rem,ext}[n] are the user's speech and the external sounds, respectively, as captured at the remote device(s). Note that although c_{rem,own}[n] is correlated with s[n], it is not assumed that there exists a linear time-invariant relationship between them. Small movements by the user will change the acoustic path enough to harm phase coherence between the local and remote devices, especially at higher frequencies.

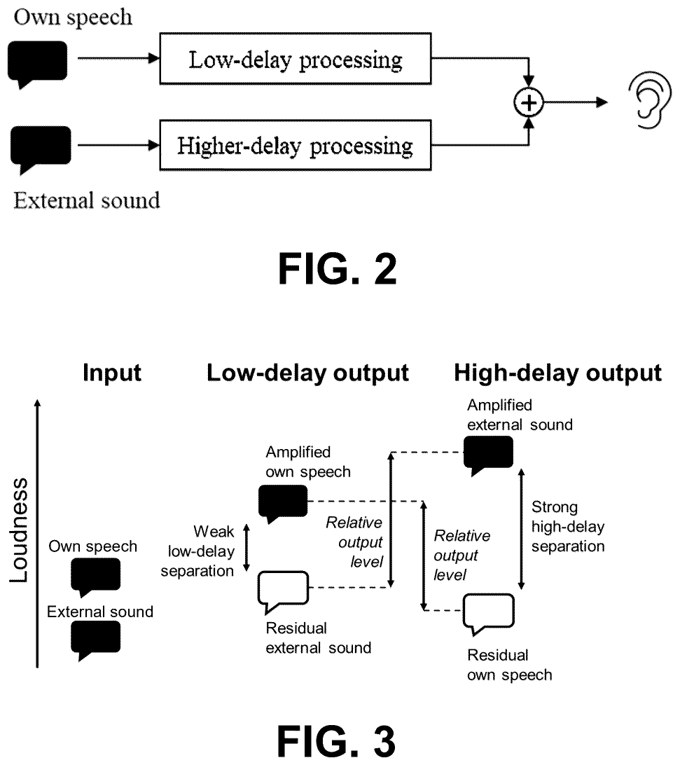

Although a hearing system would output a binaural signal in general, for simplicity consider a single ear. FIG. 2 graphically illustrates the dual low and high latency processing pathways for the audio signals from the own speech and external sound. In the simplest case where the processing to be applied is frequency-independent gain, the desired output of the mixed-delay beamforming system is:

$$y [ n ] = {G}_{own} ( {h}_{0} * s ) [ n - {α}_{own} ] + {G}_{ext} {c}_{0 , e x t} [ n - {α}_{ext} ] \qquad ( 4 )$$

where h₀ is the element of h_{loc,own} corresponding to the ear reference microphone, c_{0,ext} is the external sound component in the same microphone, α_{own} is the target processing delay for own-speech sounds, and αₑₓₜ is the target processing delay for external sounds. The flat gains G_{own} and Gₑₓₜ could be replaced with other linear or nonlinear processing, such as frequency-dependent gain, dynamic range compression, or further source separation among the external sounds.

The local microphone signals are available to the hearing device instantaneously, but the remote signals are delayed. For simplicity, consider a constant delay of D samples so that the length M=M_{loc}+Mᵣₑₘ observed data vector is:

$$x [ n ] = [ \begin{matrix}{x}_{loc} [ n ] \\ {x}_{r e m} [ n - D ]\end{matrix} ] . \qquad ( 5 )$$

Causal Sidelobe Cancellation. The central problem is to estimate the delayed own-speech signal y_{own}[n]=(h₀*s)[n−α_{own}] based on the microphone inputs x[n]∈ [symbol] ^{M}. A popular multichannel estimation approach is the minimum variance distortionless response (MVDR) beamformer, which solves the optimization problem:

$$\begin{matrix}{min}_{w} 𝔼 [ {\vert ( {w}^{T} * x ) [ n ] \vert}^{2} ] & s . t . ( {w}^{T} * h ) [ n ] = {h}_{0} [ n - α ]\end{matrix} , \qquad ( 6 )$$

where w[n]∈ [symbol] ^{M} is a vector of filter impulse responses and h[n] is the impulse response of the source of interest. The constraint ensures that signals parallel to h are unchanged by the beamformer except for delay. This constrained optimization problem can be transformed into an unconstrained optimization problem by separating the filter into two orthogonal components:

$$w [ n ] = {w}_{0} [ n ] - ( B * {w}_{c} ) [ n ] , \qquad ( 7 )$$

where the fixed beamformer satisfies the distortionless constraint

$$( {w}_{0}^{T} * h ) [ n ] = {h}_{0} [ n - α ] ,$$

the blocking matrix satisfies (B^{T}*h)[n]=0, and w_{c} is a noise cancellation filter that can be optimized without constraint to minimize the overall output power. This structure is the celebrated generalized sidelobe canceller (GSC), which is equivalent to the MVDR beamformer.

The own-speech application utilizes a slightly altered structure, shown in FIG. 1A. Because the remote signals are delayed relative to the ears, they cannot be used as inputs to the fixed beamformer. Instead, only the local microphones are used. Because h_{loc,own}[n] is fixed and known, a causal fixed beamformer w₀[n]∈ [symbol] ^{M}^{_{loc}} is computed that satisfies

$$( {w}_{0}^{T} * {h}_{loc , own} ) [ n ] = {h}_{0} [ n - {α}_{own} ] .$$

This filter uses the local microphones to predict the user's own speech as heard at the ear. It provides relatively weak separation on its own. This is illustrated in the example of FIG. 3, which shows a weak low-delay separation between the amplified own speech and residual external sound for the low latency processing path and a strong high-delay separation between the amplified external sound and residual own speech for the high latency processing path.

The blocking matrix, meanwhile, uses all available microphone signals to suppress the user's speech. The output is:

$${\hat{c}}_{ext} [ n ] = ( {B}^{T} * x ) [ n ] . \qquad ( 8 )$$

This estimate of the external sound is processed by a cancellation filter so that the overall output of the own-speech path is:

$${\hat{y}}_{own} [ n ] = ( {w}_{0}^{T} * {x}_{loc} ) [ n ] - ( {w}_{c}^{T} * {\hat{c}}_{ext} ) [ n ] . \qquad ( 9 )$$

The external sound processing path can use the cancellation filter output

$${\hat{y}}_{ext} [ n ] = ( {w}_{c}^{T} * {\hat{c}}_{ext} ) [ n ]$$

directly as a low delay estimate of the external sound at the ears or it could instead further process ĉₑₓₜ[n] to obtain a more accurate higher delay estimate.

Cancellation Filter. For example, the adaptive cancellation filter can be configured based on the optimization of the unconstrained optimization problem. The length-L cancellation filter is chosen to solve the unconstrained optimization problem:

$${min}_{{w}_{c}} 𝔼 [ {\vert {\hat{y}}_{own} [ n ] \vert}^{2} ] . \qquad ( 10 )$$

$$Let \overline{c} [ n ] = {[ {\hat{c}}_{ext}^{T} [ n ] , {\hat{c}}_{ext}^{T} [ n - 1 ] , ... , {\hat{c}}_{ext}^{T} [ n - L + 1 ] ]}^{T}$$

be the stacked vector of blocking matrix outputs. The causal minimum mean-square-error solution to (10) is the stacked filter vector:

$${\overline{w}}_{c} = {𝔼 [ \overline{c} [ n ] {\overline{c}}^{T} [ n ] ]}^{- 1} 𝔼 [ \overline{c} [ n ] ( {w}_{0}^{T} * {x}_{loc} ) [ n ] ] . \qquad ( 11 )$$

Unlike the stable own-speech path h_{loc,own}[n], the acoustic transfer functions from external sound sources to the ear vary rapidly. Thus, w_{c} must be adapted as the user moves and the source statistics change. Here (10) is solved using the normalized least-mean-squares algorithm with first-order prewhitening:

$${\overline{w}}_{c} [ n + 1 ] ← {\overline{w}}_{c} [ n ] + μ \frac{{\tilde{y}}_{own} [ n ] \tilde{c} [ n ]}{{‖ \tilde{c} [ n ] ‖}^{2}} , \qquad ( 12 )$$

where 0<μ<1 is the step size and \tilde{γ}_{own} and \tilde{c} are high-emphasis filtered versions of ŷ_{own} and c̅, respectively.

To prevent own-speech cancellation, the coefficients of w_{c} are updated only when the user is not talking. Hearing devices are well suited to perform voice activity detection (VAD) because they are physically attached to the talkers. For example, many premium earphones contain accelerometers that can reliably capture the user's low-frequency speech. In the experiments presented here, VAD is performed using headset microphones as a proxy for specialized VAD hardware.

Blocking Matrix. In one example, the blocking matrix can be configured using a weighted multichannel Wiener filter with full-rank source covariance model. The blocking matrix is a crucial component of any GSC-like structure. In order for the cancellation filter to converge correctly, there must be as little target signal “leakage” as possible into the cancellation path. Normally, a GSC blocking matrix has dimension M×M−1 and is designed so that the target signal is in the nullspace, that is, (B^{T}*h)[n]=0 for a target impulse response vector h[n]∈ [symbol] ^{M}. However, in this problem only part of the impulse response is known and fixed. Because some of the microphones are attached to a human, the channel is rapidly time-varying. Therefore, instead of a traditional blocking matrix with a rank-1 nullspace, the experiments presented here use a weighted multichannel Wiener filter (MWF) with a full-rank source covariance model. The stacked time-domain coefficients of the M-input, M-output weighted MWF are given by:

$$\overline{B} = {( λ {\overline{R}}_{own} + {\overline{R}}_{ext} )}^{- 1} {\overline{R}}_{ext} , \qquad ( 13 )$$

where R̅_{own} and R̅ₑₓₜ are the stacked time-domain covariance matrices of c_{own}[n] and cₑₓₜ[n], respectively, and λ is a weight that controls the strength of own-speech suppression. In one embodiment to test this the experiments used λ=10 and empirical estimates of R̅_{own} and R̅ₑₓₜ based on separately recorded training data. In practice, the statistics will be estimated with help from the VAD.

The MWF (13) is not a proper blocking matrix because it does not have a nullspace in general. For stationary microphones and large λ, it resembles a null-steering beamformer. The full-rank model helps to compensate for uncertainty due to small relative motion. During larger head motion, especially at high frequencies, the own-voice signal may have weak coherence between the local and remote microphones, in which case the blocking matrix will rely primarily on the remote device. In the case of a tabletop microphone array like the one used in the experiments, the user is in the far field and so head motion does not strongly affect the performance of a time-invariant MWF on the remote device. More complex scenarios may require a time-varying blocking matrix.

### Perceptual Performance Criteria

The performance criteria for a mixed-delay hearing device differ from those of many other source separation systems because user disturbance depends on the relative source levels in each output path. Consider the 2×2 matrix Δ(ω) of effective transfer functions between the own-speech and external-sound inputs and outputs at the reference microphone:

$$\hat{Y} ( ω ) = {[ \begin{matrix}{G}_{own} \\ {G}_{ext}\end{matrix} ]}^{T} [ \begin{matrix}{A}_{own , own} ( ω ) & {A}_{own , ext} ( ω ) \\ {A}_{ext , own} ( ω ) & {A}_{ext , ext} ( ω )\end{matrix} ] [ \begin{matrix}{C}_{0 , own} ( ω ) \\ {C}_{0 , ext} ( ω )\end{matrix} ] . \qquad ( 14 )$$

Ideally, there would be no leakage between paths so that |A|=I. Performance will degrade when there is crosstalk from the external sound source into the own-speech path and vice versa.

The most disturbing effect of delay is own-speech echo, also known as delayed auditory feedback, which can impact speech production. Studies have shown that delay is most disturbing when the direct and delayed sounds are similar in amplitude. Thus, the system should satisfy:

$${G}_{own} \vert {A}_{own , own} ( ω ) \vert ≫ {G}_{ext} \vert {A}_{ext , own} ( ω ) \vert . \qquad ( 15 )$$

This constraint applies primarily to the external-sound processing system, which has relaxed delay constraints and may have greater resources including remote sensing and computing devices.

Perception of external sounds can also be affected by crosstalk. If the low delay and high delay components have similar level, then the listener may experience noticeable comb-filter distortion or audible echoes. To prevent this distortion, the system should satisfy:

$${G}_{ext} \vert {A}_{ext , ext} ( ω ) \vert ≫ {G}_{own} \vert {A}_{own , ext} ( ω ) \vert . \qquad ( 16 )$$

This constraint would seem to require strong external sound suppression from the low delay processing path, which has comparatively fewer resources. However, in a typical hearing-assistive use case where the external signal of interest is a distant talker, the external gain will be larger than the own-voice gain, reducing the risk of distortion. Thus, the higher delay external-sound processing system has greater performance requirements.

### Experimental Results

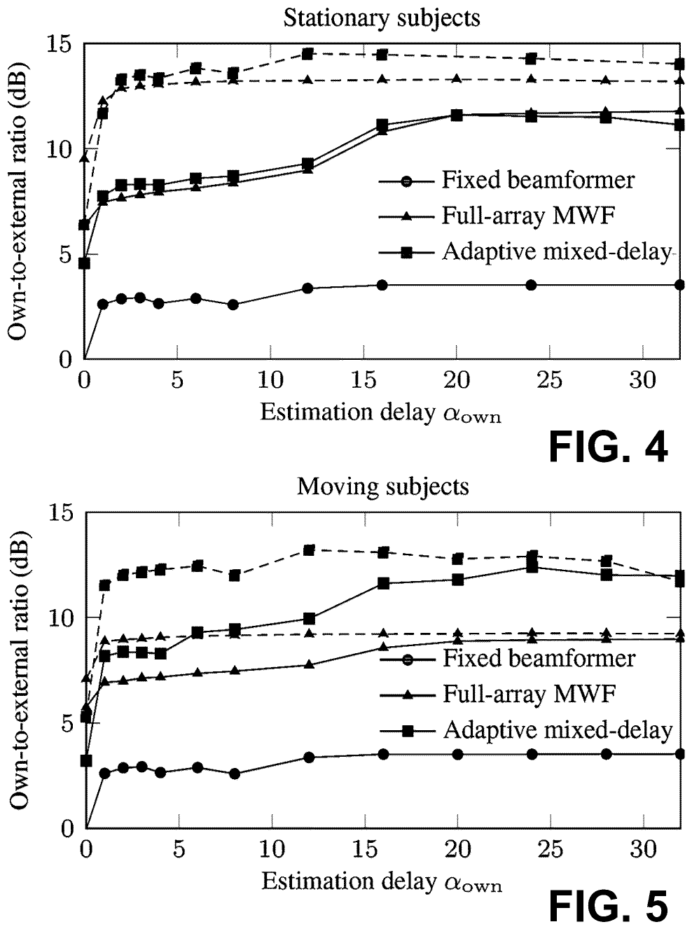

To demonstrate the efficacy of the proposed mixed-delay signal processing for hearing devices, multiple tests were performed using three human subjects seated around a table in an acoustically treated laboratory to constrain (T60≈150 ms). The three talkers took turns reading sentences aloud while stationary and while moving to simulate a group conversation and the distinction this embodiment can make to the sound. The additional data is presented in FIGS. 4-6.

Each subject wore a pair of lavalier microphones behind the ears to simulate behind-the-ear hearing aids. These, together with a lapel microphone, act as the local hearing device microphones. An eight-microphone array was placed in the center of the table and acted as the remote device. Six loudspeakers placed around the room played speech sounds from the VCTK corpus to provide additional background noise.

All signals were recorded synchronously at 48 kHz and processed at 16 kHz. The finite-impulse-response filters had length L=1024, corresponding to 64 ms. A simulated delay of 16 ms, which is comparable to the delay of current latency-optimized Bluetooth implementations, was applied to the remote device in some experiments. The fixed beamformer and blocking matrix were calibrated using training data from separate recordings of each of the three human talkers and the background noise.

Own-speech separation performance. The performance of the beamformer depends on the delay D of the remote device(s) and on the estimation delays α_{own} and αₑₓₜ. FIGS. 4 and 5 show the performance of the own-speech branch at suppressing external sound for both the stationery and moving experiments and for two different values of D. The input own-to-external ratio is about 0 dB. The solid curves show a 16 ms remote device transmission delay and the dashed curves show no delay. In all cases, the fixed beamformer w₀ on its own provides only a few dB of isolation.

The proposed GSC-like architecture provides greater isolation than the fixed beamformer. In the static experiment, it achieves comparable performance to that of a causal MWF operating on the full 11-channel input data and designed using measured second order statistics from the training data. This indicates that although the proposed mixed-delay beamformer is not a true GSC, it still successfully solves the constrained optimization problem. In the moving experiment, the adaptive filter outperforms the time-invariant MWF because it can adapt to head motion.

When all data is available instantaneously (D=0), the causal filter requires only two milliseconds of delay to strongly isolate the user's speech. When the remote device data is delayed, however, the filter does not achieve maximum performance until the estimation lag matches the 16 ms transmission delay.

When the external-sound processing path is used to further separate sources or enhance a talker of interest, its delay-performance curve (not shown) has a similar sigmoid shape, with an inflection point at αₑₓₜ=D. Because users are less sensitive to delay for external sound, the external path can operate farther to the right along the curve compared to the own-speech path.

The proposed mixed-delay beamforming architecture allows a hearing device to process the user's own speech separately from external sounds. The experiments demonstrate that conventional earpieces, lapel microphones, and tabletop microphones can achieve good separation performance at low and mid-range frequencies. Extra care is needed at higher frequencies, where relative motion impacts spatial processing performance.

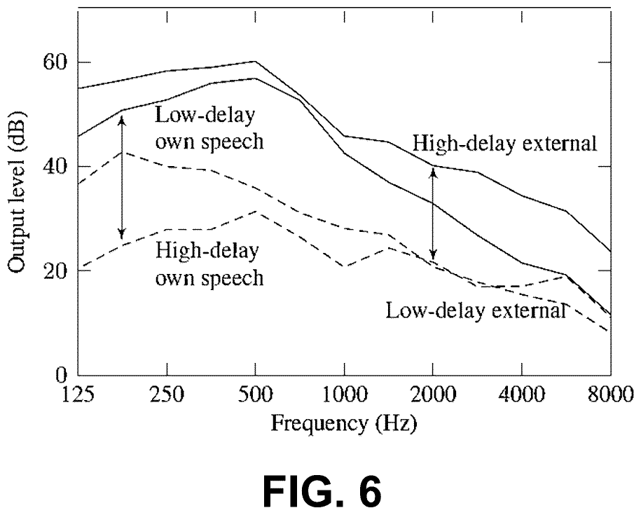

Mixed-delay sound remixing. FIG. 6 shows the output levels of the user's speech and one external talker in a remixing system with α_{own}=2 ms and αₑₓₜ=D=16 ms. The system applies 10 dB stronger gain to the external talker (Gₑₓₜ) than to the user's speech (G_{own}). Although there is nonnegligible external sound in the low-delay path, the external talker's voice is about 15-20 dB stronger in the high-delay path, making perceptible echoes or comb-filter distortion unlikely. Likewise, the own-speech echo from the high-delay path is suppressed by 20-30 dB at low and mid-range frequencies, preventing disturbing delayed auditory feedback. There is less suppression in the high-frequency range where the own-speech acoustic pathway is weak. This differential in delay effects across frequency is a well-known problem in hearing aids, which often provide stronger gain at high frequencies

It is important to note that in the typical hearing-assistive use case where distant talkers are to be amplified more strongly than the user's own speech, the low delay separation path does not need to perform particularly well. As long as the higher delay path can strongly suppress own-speech echo, the amplified and delayed external sound will overwhelm residual low delay sounds, preventing noticeable distortion. Thus, the mixed-delay architecture shifts the performance burden onto the higher delay path, which can take advantage of greater temporal context and can leverage information from wireless devices.

For example, the sound separation to give the same result as the above sound suppression and amplification of the low delay and high delay sound source can be performed by other methods. In various embodiments, the sound separation performed by the DSP can be conducted through neural networks. The network, which can use one or multiple microphones, can be trained to split the incoming sound signal into two output signals, one containing the main signal and the other containing all other sounds. In contrast to later processing stages that might use more complicated neural networks with greater delay to achieve greater separation and enhancement performance, this separation stage can be trained to prioritize low processing delay. For example, if the input to a causal neural network is a mixture of the main signal and other sounds from the environment, the target output used for training would be the main signal alone shifted by D milliseconds, where D is the allowable delay of the initial low latency separation stage. This is mathematically equivalent to allowing the network to use D milliseconds of future data to generate its output. Additional discussion regarding the training of neural networks for audio signal separation can be found in, e.g., “Low latency sound source separation using convolutional recurrent neural networks” by Gaurav Naithani et al. (IEEE Workshop on Applications of Signal Processing to Audio and Acoustics (WASPAA), 2017), “Tasnet: time-domain audio separation network for real-time, single-channel speech separation” by Yi Luo and Nima Mesgarani (IEEE International Conference on Acoustics, Speech and Signal Processing (ICASSP), 2018), and “Deep neural network based speech separation optimizing an objective estimator of intelligibility for low latency applications” by Gaurav Naithani et al. (International Workshop on Acoustic Signal Enhancement (IWAENC), 2018).

In various embodiments, the sound separation performed by the DSP can be conducted through AI. For example, a machine learning model can be trained to recognize a particular user's own voice and isolate it from all remaining sounds. All sounds not recognized as the user's own voice can be considered external sounds. For example, a general AI model could be initially trained to separate speech based on talker voice using speech from many talkers, then calibrated to target the voice of the particular user based on sample recordings of the user's voice.

In various embodiments, the sound separation performed by the DSP can be conducted through strategic placement of microphones or a microphone array. For example, a headset or lapel microphone placed close to the user's mouth can effectively isolate the user's own speech from external sounds without further processing. Similarly, the external sounds can be provided by additional devices worn or carried by other talkers or placed elsewhere in the room. In various embodiments, a separate wireless hearing device worn by another talker can transmit a signal containing the talker's speech to the user's own hearing device.

In various embodiments, the sound separation performed by the DSP can be conducted through blind source separation or blind source extraction. An iterative algorithm can update an unmixing matrix designed to estimate the main signal. This matrix is applied to the microphone inputs to generate the main signal estimate for the low-delay processing path. The remaining signal (i.e., the difference between the input and the main signal estimate) is considered to be the external sound and is processed by the higher-delay path.

In various embodiments, the sound separation performed by the DSP can be conducted through a time-frequency masking algorithm, such as the well-known Degenerate Unmixing Estimation algorithm. A classifier, which can use one or more microphones as inputs, labels each time-frequency sample as belonging to the main source or not belonging to the main source. The resulting time-frequency mask can be applied to estimate the main signal and the complementary mask is applied to estimate the external sounds.

In various embodiments, the sound separation performed by the DSP can be conducted through multichannel non-negative matrix factorization or non-negative tensor factorization. Because the user is always in the same position relative to the earpiece microphones, a fixed dictionary of spatial activation functions can be used to initialize the factorization algorithm. Signal components corresponding to this fixed set of spatial activation functions can be assigned to the main signal, while signal components associated with other spatial activation functions are assigned to the external signal.

In hearing/listening devices, such as hearing aids and augmented-reality headsets, it can be desirable to apply separate processing to the user's own speech and to external sounds. In particular, listeners are most sensitive to processing delay for their own speech. If own speech signals are processed along a dedicated low-delay pathway, then complex external sounds can be processed with more relaxed delay constraints. This approach is especially relevant to high latency digital wireless systems, such as remote microphones and distributed sensor networks. The proposed mixed-delay beamforming system isolates the user's own speech using a two-path structure resembling a sidelobe canceller. A fixed, causal beamformer can be applied to the local microphones of the hearing/listening device. A second adaptive beamformer uses inputs from both local and remote microphones to separate external sounds. The proposed system was demonstrated using recordings of a group conversation with stationary and moving subjects.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

The term “substantially” is meant to permit deviations from the descriptive term that don't negatively impact the intended purpose. Descriptive terms are implicitly understood to be modified by the word substantially, even if the term is not explicitly modified by the word substantially.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1% to about 5%, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”.

Therefore, at least the following is claimed:

1. A communication device, comprising:
at least one microphone positioned to capture sound signals from a surrounding environment; and
processing circuitry operatively connected to the at least one microphone, where the processing circuitry is configured to generate audio signals from the sound signals captured by the at least one microphone and process the audio signals through dual algorithmic processing, whereby:
audio signals corresponding to a main source of sound are processed with a first low latency or delay to generate processed audio signals;
audio signals corresponding to a secondary source of sound are processed with a second latency or delay to generate processed audio signals, the second latency or delay higher than the first low latency or delay; and
the processed audio signals are output to an output transducer for user hearing.

2. The communication device of claim 1, wherein the communication device is a hearing device.

3. The communication device of claim 1, wherein the main source of sound is a user's own speech or an external talker's speech.

4. The communication device of claim 1, wherein the processing circuitry separates the audio signals from the main source of sound and audio signals from the secondary source of sound.

5. The communication device of claim 1, wherein the at least one microphone comprises a microphone array.

6. The communication device of claim 1, wherein the processing circuitry comprises a fixed beamformer configured to receive sound signals from the at least one microphone and provide the audio signals from the main source of sound for processing with the first low latency or delay.

7. The communication device of claim 6, wherein the processing circuitry comprises a blocking matrix configured to receive the sound signals from the at least one microphone and provide the audio signals from the secondary source of sound for processing with the second higher latency or delay.

8. The communication device of claim 7, wherein the processing circuitry comprises an adaptive cancellation filter configured to receive the audio signals corresponding to the secondary source of sound from the blocking matrix and provide a filtered output for cancellation of the audio signals from the main source of sound from the fixed beamformer.

9. The communication device of claim 1, wherein audio signals corresponding to a tertiary source of sound are processed with a third latency or delay to generate processed audio signals, the third latency or delay higher than the first low latency or delay and different than the second latency or delay.

10. The communication device of claim 1, wherein the communication device is wearable by a user.

11. The communication device of claim 1, wherein the communication device is paired with a second communication device of claim 1, the paired communication devices jointly processing the audio signals captured by the at least one microphone.

12. A communication system, comprising:
at least one microphone positioned to capture sound signals from a surrounding environment; and
processing circuitry wirelessly connected to the at least one microphone, where the processing circuitry is configured to receive audio signals generated from the sound signals by the at least one microphone and process the audio signals through dual algorithmic processing, whereby:
audio signals corresponding to a main source of sound are processed with a first low latency or delay to generate processed audio signals;
audio signals corresponding to a secondary source of sound are processed with a second latency or delay to generate processed audio signals, the second latency or delay higher than the first low latency or delay; and
the processed audio signals are output to an output transducer for user hearing.

13. The communication device of claim 12, wherein a communication device wearable by a user comprises the processing circuitry and the at least one microphone comprises at least one remotely located microphone.

14. The communication system of claim 12, wherein the processing circuitry separates the audio signals from the main source of sound and audio signals from the secondary source of sound.

15. A method for mixed-delay signal processing, comprising:
generating audio signals from sound signals received by one or more microphone;
separating audio signals corresponding to sound signals associated with a main source of sound from the generated audio signals;
separating audio signals corresponding to sound signals associated with a secondary source of sound from the generated audio signals;
processing the audio signals corresponding to sound signals associated with the main source of sound at a first low latency or delay to generate first processed audio signals;
processing the audio signals corresponding to sound signals associated with the secondary source of sound at a second latency or delay to generate second processed audio signals, the second latency or delay higher than the first low latency or delay; and
combining the first and second processed audio signals for output to an output transducer.

16. The method of claim 15, wherein the audio signals corresponding to sound signals associated with the main source of sound are separated using a fixed beamformer.

17. The method of claim 15, wherein the audio signals corresponding to sound signals associated with the main source of sound are separated using a neural network.

18. The method of claim 15, wherein the audio signals corresponding to sound signals associated with the secondary source of sound are separated using a blocking matrix.

19. The method of claim 15, wherein the main source of sound is a user's own speech and the secondary source is an external talker's speech.

20. The method of claim 15, further comprising:
separating audio signals corresponding to sound signals associated with a tertiary source of sound from the generated audio signals;
processing the audio signals corresponding to sound signals associated with the tertiary source of sound at a third latency or delay to generate third processed audio signals, the third latency or delay higher than the first low latency or delay and different than the second latency or delay; and
combining the third processed audio signals with the first and second processed audio signals for output to the output transducer.
